(19) United States
(12) Patent Application Publication
(10) Pub. No.: US 2007/0012901 A1
(43) Pub. Date: Jan. 18, 2007

(54) Virtual electronic perimeter fence with solar powered lights

(75) Inventors: Shawn Mikuski, Brick, NJ (US); Rein Teder, Eden Prairie, MN (US); Richard Holstein, Lakewood, NJ (US)

Correspondence Address: BIRCH STEWART KOLASCH & BIRCH, PO BOX 747, FALLS CHURCH, VA, 22040-0747, US

(73) Assignee: SMARTPOOL INCORPORATED, Lakewood, NJ (US)

(21) Appl. No.: 11/413,169

(22) Filed: Apr. 28, 2006

Related U.S. Application Data
(60) Provisional application No. 60/675,877, filed on Apr. 29, 2005.
(60) Provisional application No. 60/722,416, filed on Oct. 3, 2005.

(51) Int. Cl. A01K 3/00

(52) U.S. Cl. 256/10

(57) ABSTRACT

A virtual electronic perimeter fence includes at least a first, second and third fence post each including an emitter for emitting a beam of infrared light at a predetermined frequency. The first, second and third fence posts include a receiver for receiving the predetermined frequency of infrared light emitted from a designated fence post. A beam of infrared light of a first frequency is emitted from the first fence post to the second fence post and a beam of infrared light of a second frequency is emitted from the second fence post to the third fence post and infrared light of a third frequency is emitted from the third fence post to the first fence post for providing a virtual electronic perimeter fence that provides an alarm if an interruption occurs in the beam of infrared light while eliminating cross-signals therebetween. A light, sound and video system may be provided.

### CROSS-REFERENCE TO RELATED APPLICATIONS

The present application claims priority under 35 USC 119 to U.S. Provisional Patent Application Nos. 60/675,877 filed on Apr. 29, 2005 and 60/722,416 filed on Oct. 3, 2005 the entire contents of which are hereby incorporated by reference.

### BACKGROUND OF THE INVENTION

1. Field of the Invention

The present invention is directed to a virtual electronic perimeter fence that includes solar panels and lights for illumination and speakers for sound. More specifically, to solar panels and lights that are used together with an electronic perimeter fence that utilizes infrared light of a predetermined frequency that is orchestrated between adjacent fence posts to provide security for generating an alarm if data is not properly emitted and received while eliminating cross-signals between fence posts.

2. Description of Background Art

Heretofore, fences have been available with fence post positioned at predetermined intervals. The fence posts do not include solar powered lights or any illumination. In addition, electronic fences have been designed that transmit a certain frequency of infrared light from one fence post to an adjacent fence post. The receivers and emitters in a particular fence post are designed to receive and emit the same frequency therebetween.

A problem results in prior electronic fences due to the fact that the post do not include any illumination. In addition, a cross-signal can be sent to one of the fence posts to incorrectly indicate that the area is secure wherein a portion of the area has been compromised. In other words, a first fence post that is designed to transmit a beam of infrared light to an adjacent second fence post actually transmits the beam of light to a third fence post. The continuous beam of light is received back to the controller to indicate that the fenced area is secured. However, since the first fence post is actually transmitting a beam of light to the third fence post, the secured area is actually compromised with a portion of the secured area being open to intruders.

### SUMMARY AND OBJECTS OF THE INVENTION

It is an object of the present invention to provide a combination of elements wherein a fence post can be equipped with a solar panel and a light for providing illumination to the area adjacent to the fence post. In addition, a first fence post is provided that includes an emitter for emitting a beam of infrared light at a first frequency to a second fence post. The second fence post includes a receiver that is designed to receive the first frequency of infrared light emitted from the first fence post. The second fence post includes an emitter for emitting a beam of infrared light at a second frequency to a third fence post. The third fence post includes a receiver that is designed to receive the second frequency of infrared light emitted from the second fence post. The third fence post includes an emitter for emitting a beam of infrared light at a third frequency to a fourth fence post. The fourth fence post includes a receiver that is designed to receive the third frequency of infrared light emitted from the third fence post. The fourth fence post includes an emitter for emitting a beam of infrared light at a fourth frequency to the first fence post. The first fence post includes a receiver that is designed to receive the fourth frequency of infrared light emitted from the fourth fence post. In this way, a particular frequency of infrared light is emitted and received by adjacent fence posts without the possibility of a cross-signal connection.

The present invention provides a combination of elements wherein the frequency of infrared light is orchestrated between adjacent fence posts to provide a virtual electronic perimeter fence. The orchestration of the infrared light between adjacent fence posts provides security for generating an alarm if data is not properly emitted and received while eliminating cross-signals between fence posts.

In a second embodiment of the present invention, each fence post may be equipped with two emitters and a receivers. A first emitter and receiver is disposed at a certain height above a base for the fence post. A second emitter and receiver is disposed at a predetermined height above the first emitter and receiver so as to provide two infrared light beams that are transmitted between adjacent fence posts without the possibility of a cross-signal connection.

In another embodiment of the present invention, each fence post is provided with a solar panel and an accent light for illuminating the area adjacent to the fence post.

Each fence post may include a solar panel that may be connected to a battery or other energy storage device for facilitating an overflow of electrical energy and for supplying the post with power during the evening or other times of darkness. This embodiment eliminates the need to run wires for providing power to the system.

In another embodiment of the present invention, each fence post is directly provided with low voltage power or conventional power for illuminating a light mounted on the fence post for providing illumination to the area adjacent to the fence post.

In another embodiment of the present invention, each fence post is provided with a speaker for providing sound in the area adjacent to the fence post. The speakers may be wired directly to a radio, stereo or amplifier or may be wireless.

In another embodiment of the present invention, at least one fence post may be provided with a video surveillance camera to survey and record activity in the pool area. The camera may receive power from a post line voltage, a solar collector or a battery. A signal generated by the camera may be sent by wifi or a wired transmission to a viewing or recording device.

In addition, at least one of the fence post may be provided with flood lights to provide bright lights for night swimming. The flood lights may receive power from a post line voltage, a solar collector or a battery.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic illustration of the flow of data from control posts to processors;

FIG. 2 is a schematic illustration of four control posts with emitters and receivers disposed on each of the control posts;

FIG. 3 is a perspective view of a control post with emitters and receivers disposed within;

FIG. 4 is an enlarged view of an emitter and a receiver for positioning within a control post;

FIG. 5 is a top plan view illustrating symbols for orienting a control post with an adjacent control post;

FIG. 6 is a perspective view of a control post with notations for alignment light emitting diodes (LED);

FIG. 7 is an illustration of a solar panel and solar light that may be mounted on a top portion of a fence post;

FIG. 8 is an illustration of a light that may be mounted on a fence post and illuminated by hard wiring;

FIG. 9 is an illustration of a speaker that may be mounted on a fence post and powered by either hard wiring or may be powered with a wireless connection;

FIG. 10 illustrates a top cover for use in attaching the solar light;

FIG. 11 illustrates the top cover operatively mounted on a fence post;

FIG. 12 illustrates the top cover that is rotated downwardly to cover the top of the fence post to make a seal;

FIG. 13 illustrates a light fixture that is mounted on the top cover;

FIG. 14 illustrates a solar light that is mounted on the light fixture and

FIG. 15 illustrates a video surveillance camera mounted on a fence post.

### DETAILED DESCRIPTION OF THE PREFERRED EMBODIMENTS

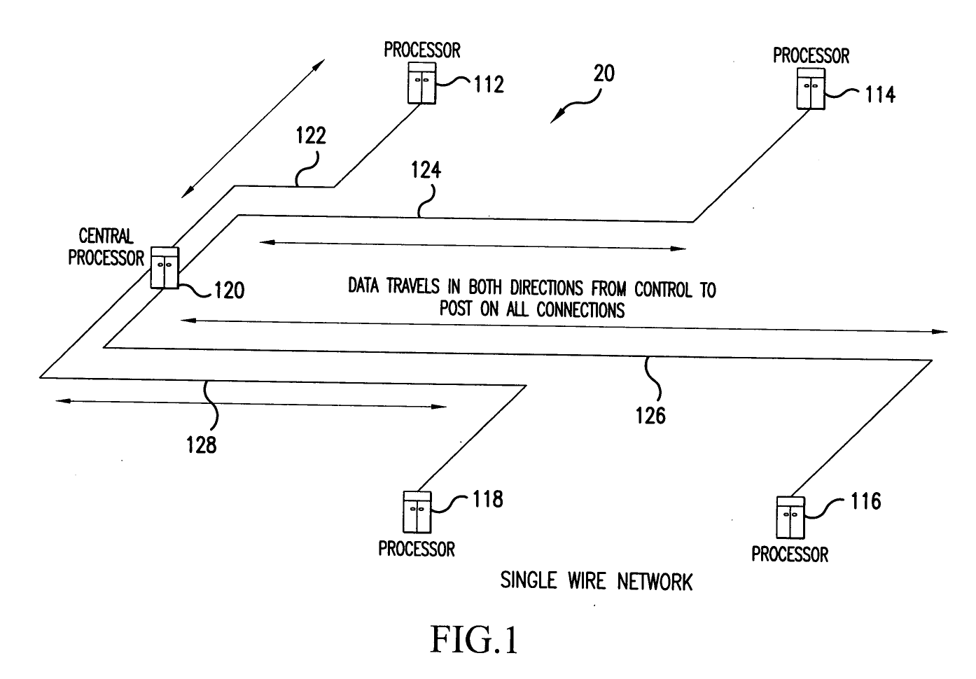

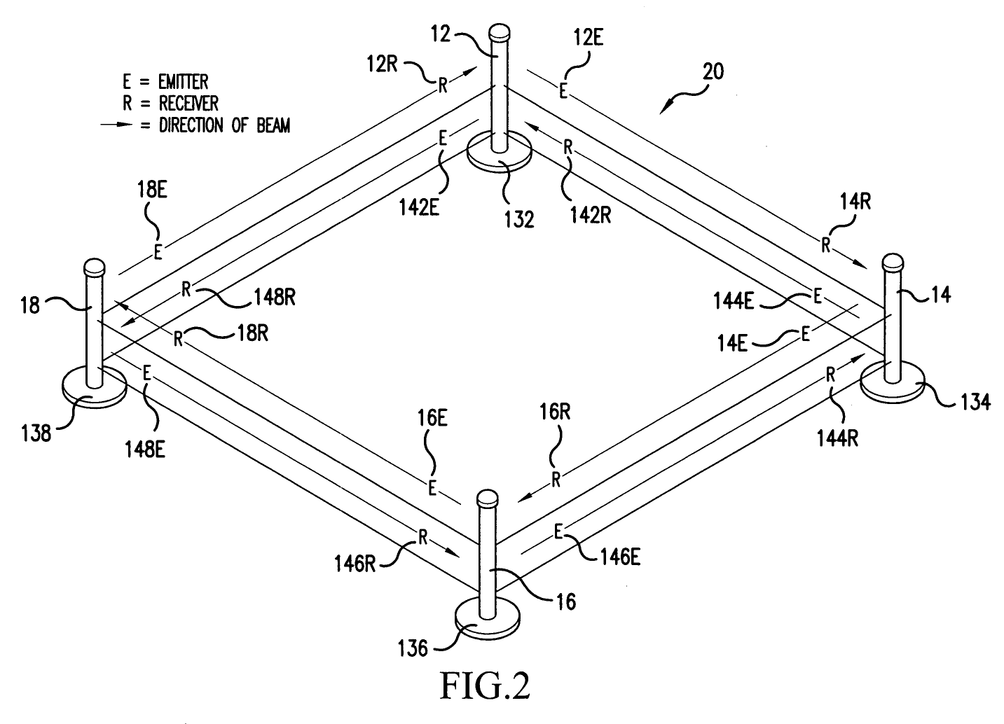

As illustrated in FIG. 1-4, a virtual electronic perimeter fence 20 is provided with a first fence post 12 including an emitter 12E for emitting a beam of infrared light at a first frequency. A second fence post 14 is displaced a predetermined distance relative to the first fence post 12. The second fence post 14 includes a receiver 14R for receiving the first frequency of infrared light emitted from the emitter 12E disposed on the first fence post 12. The second fence post 14 includes an emitter 14E for emitting a beam of infrared light at a second frequency. A third fence post 16 includes a receiver 16R for receiving the second frequency of infrared light emitted from the emitter 14E disposed on the second fence post 14. The third fence post 16 includes an emitter 16E for emitting a beam of infrared light at a third frequency.

In one embodiment of the present invention, the third emitter 16E may be positioned to transmit the beam of infrared light at the third frequency back to a receiver 12R disposed on the first fence post 12. In this embodiment, three fence posts would define a secured area.

In a second embodiment, a fourth fence post 18 may be provided that includes a receiver 18R for receiving the third frequency of infrared light emitted from the third fence post. The fourth fence post 18 includes an emitter 18E for emitting a beam of infrared light at a fourth frequency to the first fence post 12. The first fence post 12 includes a receiver 12R for receiving the fourth frequency of infrared light emitted from the fourth fence post 18.

A beam of infrared light of a first frequency is emitted from the first fence post 12 to the second fence post 14. A beam of infrared light of a second frequency is emitted from the second fence post 14 to the third fence post 16. A beam of infrared light of a third frequency is emitted from the third fence post 16 to the fourth fence post 18. A beam of infrared light of a fourth frequency is emitted from the fourth fence post 18 to the first fence post 12 for providing a virtual electronic perimeter fence that provides an alarm if an interruption occurs in the beam of infrared light. In addition, in view of the fact that infrared light of predetermined frequencies is used between adjacent fence posts, the present invention eliminates cross-signals between fence posts.

The virtual electronic perimeter fence 20 further includes a control processor 120 for transmitting a signal through a signal line 122 to said first fence post 12 that includes a processor 112 for firing the first emitter 12E while sending a signal through a signal line 124 to said second fence post 14 that includes a processor 114 for initiating the second receiver 14R to receive the signal.

The control processor 120 transmits a signal through the signal line 124 to the second fence post 14 that includes the processor 114 for firing the second emitter 14E while sending a signal through a signal line 126 to said third fence post 16 that includes a processor 116 for initiating the third receiver 16R to receive the signal.

The control processor 120 transmits a signal through the signal line 126 to the third fence post 16 that includes the processor 116 for firing the third emitter 16E while sending a signal through a signal line 128 to the fourth fence post 18 that includes a processor 118 for initiating the fourth receiver 18R to receive the signal.

The control processor 120 transmits a signal through the signal line 128 to the fourth fence post 18 that includes the processor 118 for firing the fourth emitter 18E while sending a signal through the signal line 122 to the first fence post 12 that includes the processor 112 for initiating the first receiver 12R to receive the signal.

The signals that are fired to the first, second, third and fourth fence posts are fired in a clockwise direction to flash the infrared light for a nanosecond at the predetermined frequency between adjacent fence posts to predetermined receivers designed to receive the predetermined frequency. The control processor 120 transmits a signal in a clockwise direction from the emitter 12E disposed in the first fence post 12 to the receiver 14R disposed in the second fence post 14 and then to the emitter 14E disposed in the second fence post 14 to the receiver 16R disposed in the third fence post 16 and then to the emitter 16E disposed in the third fence post 16 to the receiver 18R disposed in the fourth fence post 18 and then to the emitter 18E disposed in the fourth fence post 18 to the receiver 12R disposed in the first fence post 12.

The first 12, second 14, third 16 and fourth 18 fence posts include a first emitter 12E, 14E, 16E and 18E and a first receiver 12R, 14R, 16R and 18R that are positioned at a predetermined distance relative to a base 132, 134, 136 and 138 of the first 12, second 14, third 16 and fourth 18 fence posts. A second emitter 142E, 144E, 146E and 148E and a second receiver 142R, 144R, 146R and 148R are positioned at a predetermined distance displace downwardly relative to the first emitter 12E, 14E, 16E and 18E and the first receiver 12R, 14R, 16R and 18R for providing two beams of infrared light.

As described above, the control processor 120 transmits a signal in a clockwise direction from the first emitter 12E disposed in the first fence post 12 to the first receiver 14R disposed in the second fence post 14 and then to the first emitter 14E disposed in the second fence post 14 to the first receiver 16R disposed in the third fence post 16 and then to the first emitter 16E disposed in the third fence post 16 to the first receiver 18R disposed in the fourth fence post 18 and then to the first emitter 18E disposed in the fourth fence post 18 to the first receiver 12R disposed in the first fence post 12. In addition, the control processor 120 transmits a signal in a counter-clockwise direction from the second emitter 142E disposed in the first fence post 12 to the second receiver 148R disposed in the fourth fence post 18 and then to the second emitter 148E disposed in the fourth fence post 18 to the second receiver 146R disposed in the third fence post 16 and then to the second emitter 146E disposed in the third fence post 16 to the second receiver 144R disposed in the second fence post 14 and then to the second emitter 144E disposed in the second fence post 14 to the second receiver 142R disposed in the first fence post 12.

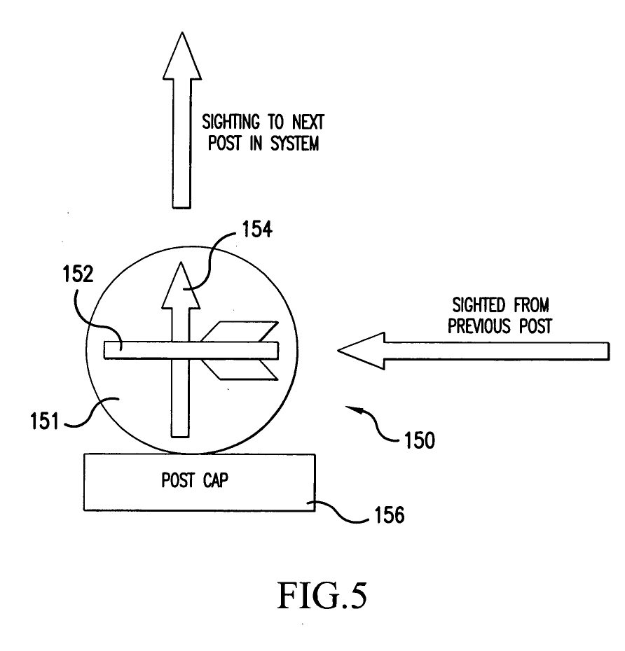

As illustrated in FIG. 5, an alignment sight 150 may be disposed on a top cap 156 of the first 12, second 14, third 16 and fourth 18 fence posts for aligning adjacent fence post relative to each other. The alignment sight 150 includes a first arrow 152 that is aligned with an arrow on an adjacent fence post and a second arrow 154 that is aligned with an arrow on other adjacent fence post.

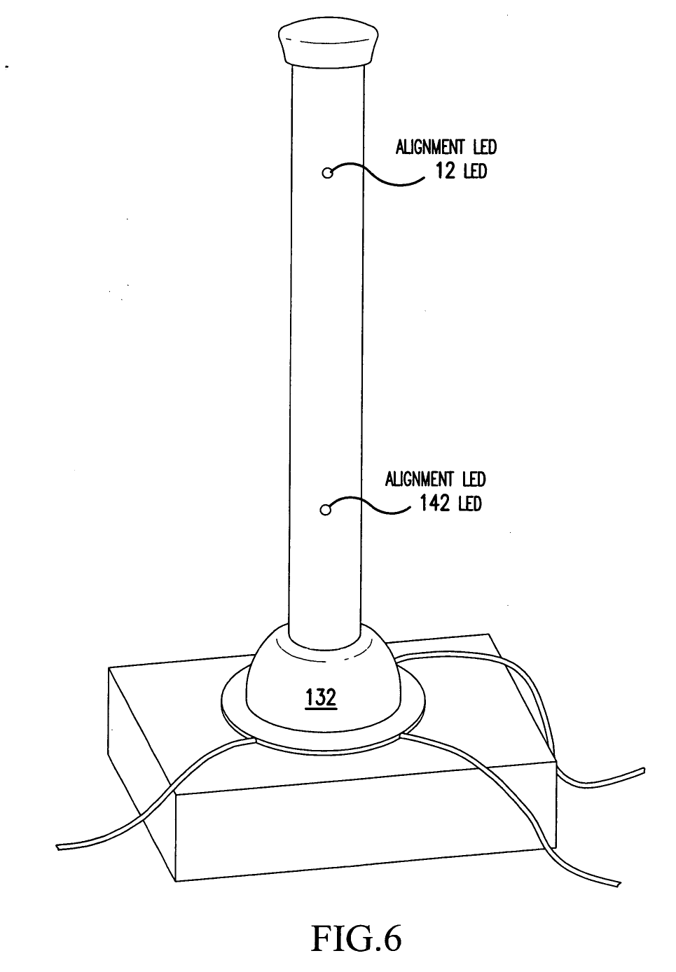

As illustrated in FIG. 6, an alignment light emitting diode 12LED is illuminated when the emitter 18E and receiver 12R of the first fence post 12 are properly aligned. Similarly, an alignment light emitting diode 142LED is illuminated with the emitter 144E and the receiver 142R of the first fence post 12 are properly aligned. The first 12, second 14, third 16 and fourth 18 fence posts include corresponding light emitting diodes to assist with the proper alignment of adjacent fence posts.

By using a particular frequency of infrared light that is emitted and received only by adjacent fence post, the possibility of a cross-signal connection is eliminated.

The present invention provides a combination of elements wherein the frequency of infrared light is orchestrated between adjacent fence posts to provide a virtual electronic perimeter fence. The orchestration of the infrared light between adjacent fence posts provides security for generating an alarm if data is not properly emitted and received while eliminating cross-signals between fence posts.

In a second embodiment of the present invention, each fence post is equipped with two emitters and two receivers. A first emitter and receiver is disposed at a certain height above a base for the fence post. A second emitter and receiver is disposed at a predetermined height below the first emitter and receiver so as to provide two infrared light beams that are transmitted between adjacent fence posts without the possibility of a cross-signal connection.

The present invention provides a single wire communication network wherein communication data is transmitted and received by both the control processor and post processors. This system sends a signal from a specified emitter to transmit the infrared light to its corresponding receiver which will accept the beam from only that emitter. If any part of this process should breakdown, the control will go into an alarm state. This process ensures that there is no possibility of a stray beam from either an outside sorce or from another emitter will cause a false positive in any quadrant of protection.

A reverse directional infrared beam is provided for upper and lower perimeter protection. The perimeter of protection is formed by an upper and lower infrared beam which operates independently of each other. The upper beam utilizes emitters that will only direct their infrared light in a clockwise fashion. The receivers on the top perimeter are all positioned in a clockwise pattern to collect the infrared energy transmitted by the top perimeter in a clockwise orientation. The lower perimeter emitters are all oriented in a counter-clockwise fashion with their corresponding receivers collecting the energy only in a counter-clockwise fashion. This process greatly reduces the possibility of a false positive arising from a stray beam from a top emitter to a bottom receiver and visa versa.

A one-piece optical window 160 encloses the emitter posts and is designed as an optical window 160 to facilitate the exit end entry of the infrared energy with a minimum of signal loss. The entire enclosure is one piece that eliminates joining an infrared window with an enclosure and greatly increases the weatherproofing and manufacturing labor of the product.

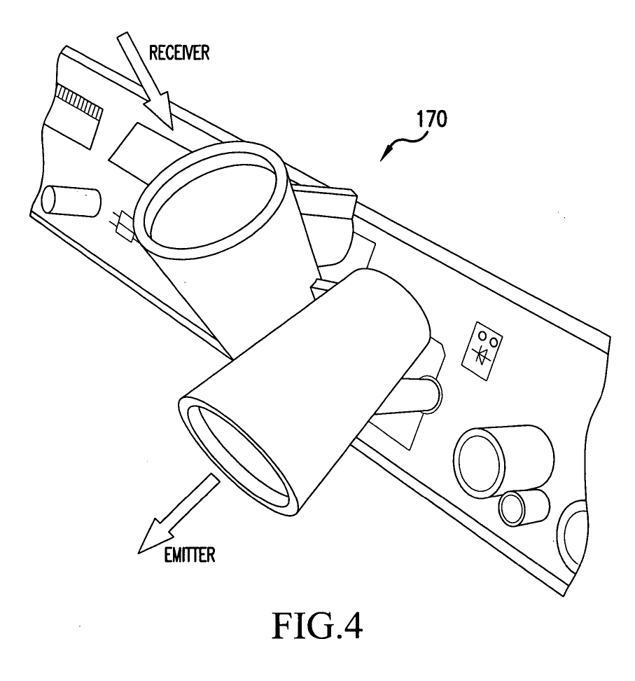

In FIG. 4, a ninety degree lens holder design 170 permits the lens holder and lens to be designed to be mounted on a circuit board 180 so they create a 90 degree angle for both emitting and collecting infrared energy. This allows for quick and easy set up of the system in either a square or rectangular or triangular configuration.

As illustrated in FIG. 5, the alignment sights on the cap 150 of each post are formed by raised arrows 152, 154 which are designed to be used as a scope or a gun sight, where when viewed at eye level, the arrows point directly at the next post in the system. This easy sighting has been designed for easy initial alignment of the overall perimeter of protection.

As illustrated in FIG. 6, on each post near the emitter and receivers are light emitting diodes (LEDS) which illuminate when predetermined emitters and receivers are aligned and the infrared signal is unblocked. This system is used during the initial set up phase to easily tell if the posts are properly aligned. This process also acts as a troubleshooting tool to determine exactly what quadrant of protection is not functioning properly.

The easy twist alignment post base 132 is designed with slots in the base to facilitate a rotation left and right to fine tune and adjust each post before tightening the unit in a permanent fastening.

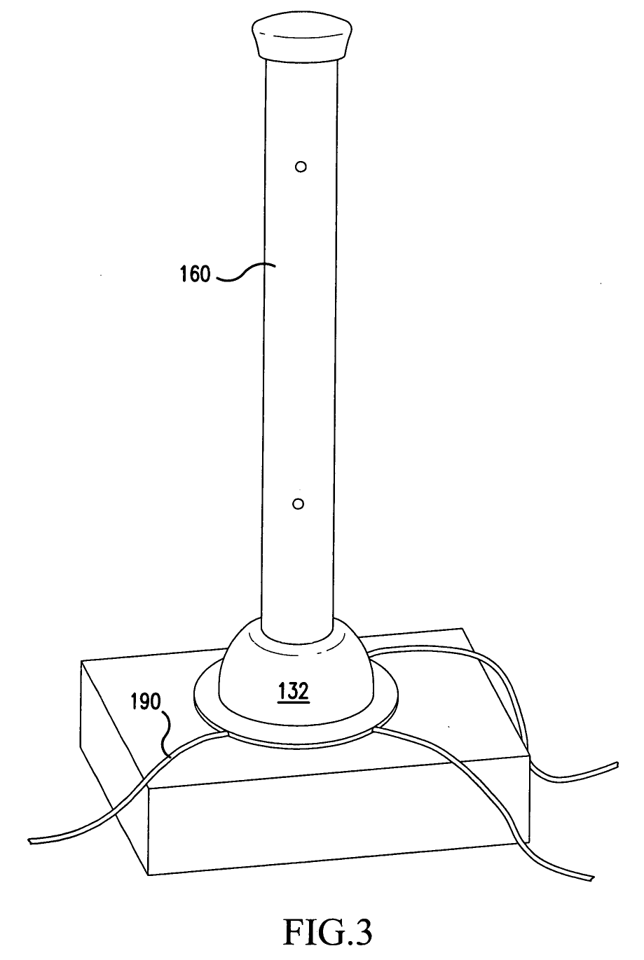

During the alignment process the control box may be programmed to beep rather than provide a constant siren to eliminate the “annoyance factor” during installation. This mode times out automatically after 15 minutes and the unit reverts back to standard operation. As illustrated in FIG. 3, the present invention operates on low voltage that is supplied to the fence posts by a power line 190.

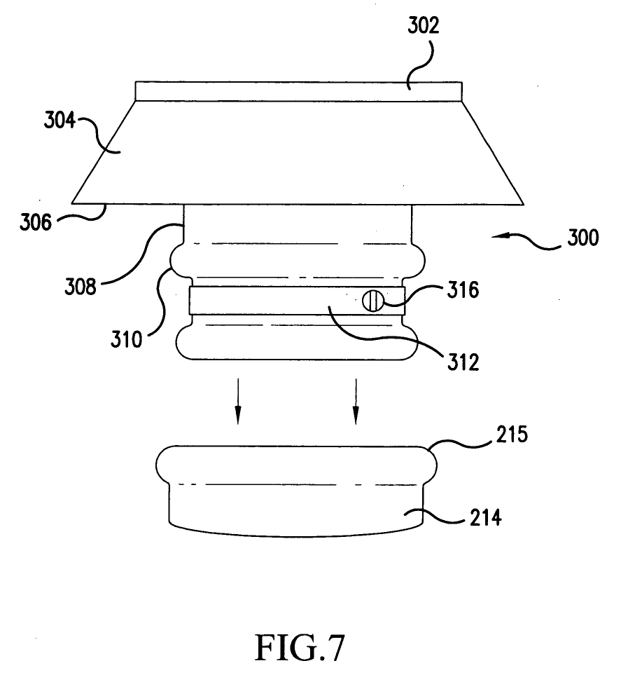

FIG. 7 illustrates a fence post 214 with an engaging portion 215 formed on an upper end thereof. A lighting housing 300 includes a solar panel 302 that is operatively connected to a solar light 306 that is mounted within the housing 304 to permit light to be illuminated downwardly therefrom. The lighting housing 300 includes a mounting member 308 with an engaging portion 310 for mating with the engaging portion 215 of the fence post 214. The mounting member 308 may be secured to the fence post 214 by means of a tension belt 312 that may be tightened by a tension screw 316. A lighting housing 300 may be mounted on a top portion of each of the fence posts of the perimeter fence for illuminating the area adjacent to the fence posts. The solar panel attached to each fence post 214 may be connected to a battery or other energy storage device for facilitating an overflow of electrical energy and for supplying the post with power during the evening or other times of darkness. In this embodiment, the need to run wires for providing power to the system is eliminated.

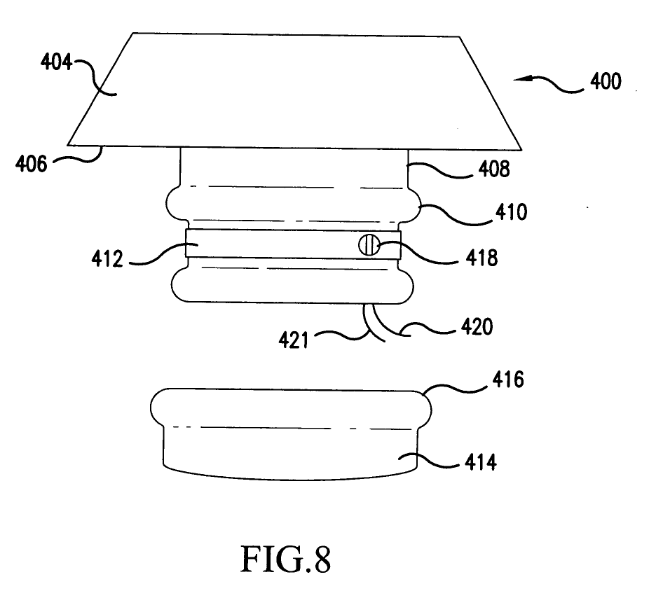

FIG. 8 illustrates a fence post 414 with an engaging portion 416 formed on an upper end thereof. A lighting housing 400 includes a light 406 that is mounted within the housing 404 to permit light to be illuminated downwardly therefrom. The lighting housing 400 includes a mounting member 408 with an engaging portion 410 for mating with the engaging portion 416 of the fence post 414. The mounting member 408 may be secured to the fence post 414 by means of a tension belt 412 that may be tightened by a tension screw 418. The light 406 may be hard wired by use of the wires 420, 421 to a low voltage source of power or to a conventional power source for illuminating the light 406. A lighting housing 400 may be mounted on a top portion of each of the fence posts of the perimeter fence for illuminating the area adjacent to the fence posts.

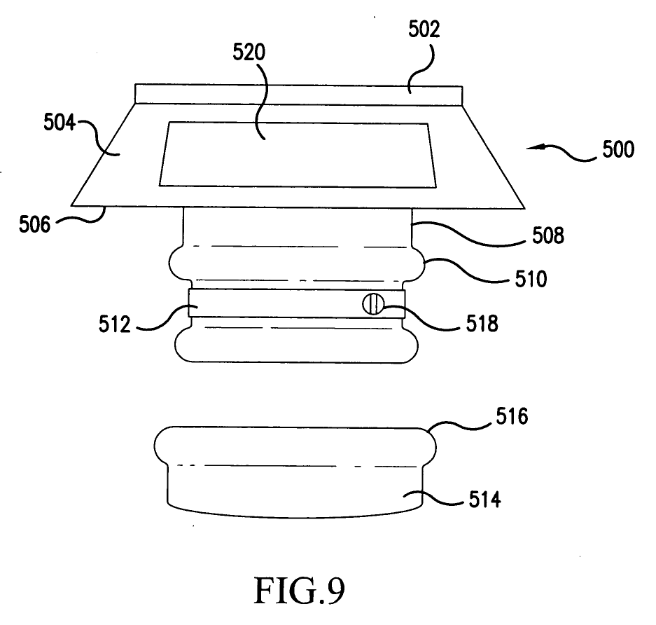

FIG. 9 illustrates a fence post 514 with an engaging portion 516 formed on an upper end thereof. A lighting housing 500 includes a speaker 520 that is mounted to provide sound to the area adjacent to the fence post 514. A solar panel 502 May be provided that is operatively connected to a solar light 506 that is mounted within the housing 504 to permit the light to be illuminated downwardly therefrom. The lighting housing 500 includes a mounting member 508 with an engaging portion 510 for mating with the engaging portion 516 of the fence post 514. The mounting member 508 may be secured to the fence post 514 by means of a tension belt 512 that may be tightened by a tension screw 518. The speaker 520 may be hard wired into a radio, stereo or amplifier for providing power and a sound signal to the speaker 520. In the alternative, the speaker 520 may have a wireless connection to a radio, stereo or amplifier for providing power and a sound signal to the speaker 520. A lighting housing 500 with a speaker 520 may be mounted on a top portion of each of the fence posts of the perimeter fence for providing sound and for illuminating the area adjacent to the fence posts.

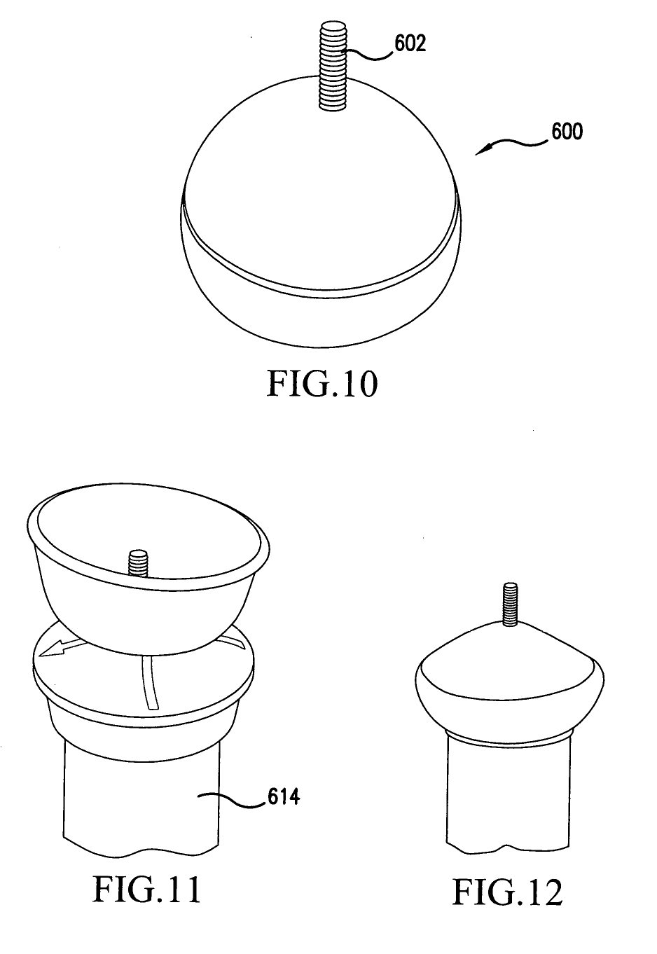

As illustrated in FIGS. 10 to 12, a top cover 600 is operatively mounted on a fence post 614. A screw 602 extends from the top cover 600 and is mounted to the fence post 614. As illustrated in FIG. 12 the top cover 600 is rotated downwardly to cover the top of the fence post 614 to make a seal. The screw 602 extends upwardly from the top cover 600 and the fence post 614 to permit a light fixture to be mounted thereto.

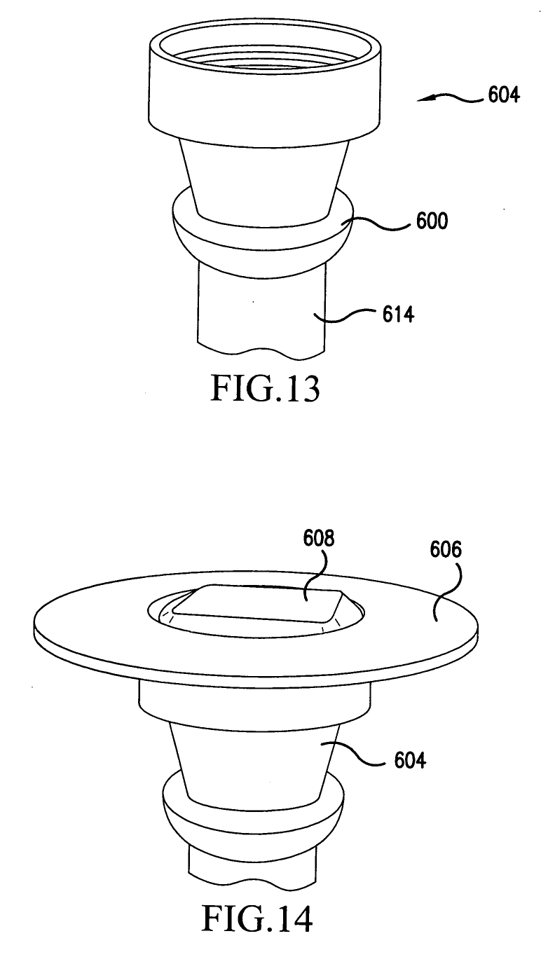

FIGS. 13 and 14 illustrates a light fixture 604 that is mounted on the top cover 600. The screw 602 extends within the housing for the light fixture 604 and a bolt is utilized to secure the light fixture 604 to the fence post 614. A solar light 606 is mounted to the light fixture 604 and is secured thereto. A solar collector 608 is provided for the solar light 606 to provide a source of power for illuminating the solar light 606.

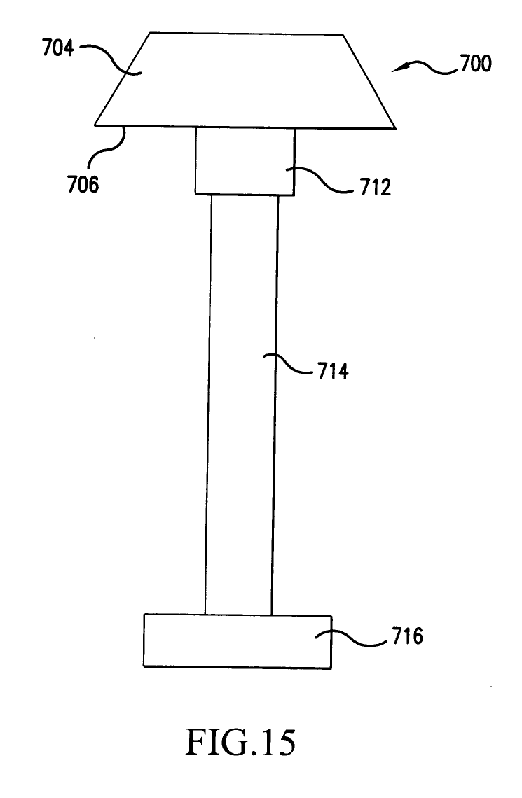

As illustrated in FIG. 15, in another embodiment of the present invention, at least one fence post 714 that includes a base 716 may be provided with a video surveillance camera 712 to survey and record activity in the pool area. The camera 712 may receive power from a post line voltage, a solar collector or a battery. A signal generated by the camera may be sent by wifi or a wired transmission to a viewing or recording device. In addition, a lighting unit 700 includes a light 706 that is mounted within the housing 704 to permit light to be illuminated downwardly therefrom. The light 706 may be hard wired by use of the wires to a low voltage source of power or to a conventional power source for illuminating the light 706. A lighting unit 700 may be mounted on a top portion of each of the fence posts of the perimeter fence for illuminating the area adjacent to the fence posts.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A virtual electronic perimeter fence comprising:
a first fence post including an emitter for emitting a beam of infrared light at a first frequency;
a second fence post displaced a predetermined distance relative to the first fence post, said second fence post including a receiver for receiving the first frequency of infrared light emitted from the first fence post, said second fence post including an emitter for emitting a beam of infrared light at a second frequency;
a third fence post including a receiver for receiving the second frequency of infrared light emitted from the second fence post, said third fence post including an emitter for emitting a beam of infrared light at a third frequency;
a fourth fence post including a receiver for receiving the third frequency of infrared light emitted from the third fence post, said fourth fence post including an emitter for emitting a beam of infrared light at a fourth frequency to the first fence post;
said first fence post including a receiver for receiving the fourth frequency of infrared light emitted from the fourth fence post;
wherein a beam of infrared light of a first frequency is emitted from the first fence post to the second fence post and a beam of infrared light of a second frequency is emitted from the second fence post to the third fence post and a beam of infrared light of a third frequency is emitted from the third fence post to the fourth fence post and a beam of infrared light of a fourth frequency is emitted from the fourth fence post to the first fence post for providing a virtual electronic perimeter fence that provides an alarm if an interruption occurs in the beam of infrared light while eliminating cross-signals between fence posts.

2. The virtual electronic perimeter fence according to claim 1, and further including a control processor for transmitting a signal to said first fence post for firing the first emitter while sending a signal to said second fence post for receiving the signal.

3. The virtual electronic perimeter fence according to claim 1, and further including a control processor for transmitting a signal to said second fence post for firing the second emitter while sending a signal to said third fence post for receiving the signal.

4. The virtual electronic perimeter fence according to claim 1, and further including a control processor for transmitting a signal to said third fence post for firing the third emitter while sending a signal to said fourth fence post for receiving the signal.

5. The virtual electronic perimeter fence according to claim 1, and further including a control processor for transmitting a signal to said fourth fence post for firing the fourth emitter while sending a signal to said first fence post for receiving the signal.

6. The virtual electronic perimeter fence according to claim 2, wherein the control processor transmits a signal in a clockwise direction from the emitter disposed in the first fence post to the receiver disposed in the second fence post and then to the emitter disposed in the second fence post to the receiver disposed in the third fence post and then to the emitter disposed in the third fence post to the receiver disposed in the fourth fence post and then to the emitter disposed in the fourth fence post to the receiver disposed in the first fence post.

7. The virtual electronic perimeter fence according to claim 1, wherein the first, second, third and fourth fence posts include a first emitter and receiver that are positioned at a predetermined distance relative to a base of the first, second, third and fourth fence posts and a second emitter and receiver that are positioned at a predetermined distance displace downwardly relative to the first emitter and receiver for providing two beams of infrared light.

8. The virtual electronic perimeter fence according to claim 7, and further including a control processor for transmitting a signal in a clockwise direction from the first emitter disposed in the first fence post to the first receiver disposed in the second fence post and then to the first emitter disposed in the second fence post to the first receiver disposed in the third fence post and then to the first emitter disposed in the third fence post to the first receiver disposed in the fourth fence post and then to the first emitter disposed in the fourth fence post to the first receiver disposed in the first fence post and then for transmitting a signal in a counter-clockwise direction from the second emitter disposed in the first fence post to the second receiver disposed in the fourth fence post and then to the second emitter disposed in the fourth fence post to the second receiver disposed in the third fence post and then to the second emitter disposed in the third fence post to the second receiver disposed in the second fence post and then to the second emitter disposed in the second fence post to the second receiver disposed in the first fence post.

9. The virtual electronic perimeter fence according to claim 1, and further including an alignment sight disposed on a top of the first, second, third and fourth fence posts for aligning adjacent fence post relative to each other.

10. The virtual electronic perimeter fence according to claim 1, and further including an alignment light emitting diode which is illuminated when the emitter and receiver of adjacent fence posts are properly aligned.

11. A virtual electronic perimeter fence comprising:
a first fence post including an emitter for emitting a beam of infrared light at a first frequency;
a second fence post displaced a predetermined distance relative to the first fence post, said second fence post including a receiver for receiving the first frequency of infrared light emitted from the first fence post, said second fence post including an emitter for emitting a beam of infrared light at a second frequency;
a third fence post including a receiver for receiving the second frequency of infrared light emitted from the second fence post, said third fence post including an emitter for emitting a beam of infrared light at a third frequency;
said first fence post including a receiver for receiving the third frequency of infrared light emitted from the third fence post;
wherein a beam of infrared light of a first frequency is emitted from the first fence post to the second fence post and a beam of infrared light of a second frequency is emitted from the second fence post to the third fence post and a beam of infrared light of a third frequency is emitted from the third fence post to the first fence post for providing a virtual electronic perimeter fence that provides an alarm if an interruption occurs in the beam of infrared light while eliminating cross-signals between fence posts.

12. The virtual electronic perimeter fence according to claim 11, and further including a control processor for transmitting a signal to said first fence post for firing the first emitter while sending a signal to said second fence post for receiving the signal.

13. The virtual electronic perimeter fence according to claim 11, and further including a control processor for transmitting a signal to said second fence post for firing the second emitter while sending a signal to said third fence post for receiving the signal.

14. The virtual electronic perimeter fence according to claim 11, and further including a control processor for transmitting a signal to said third fence post for firing the third emitter while sending a signal to said first fence post for receiving the signal.

15. The virtual electronic perimeter fence according to claim 1, and further including a control processor for transmitting a signal to said first fence post for firing the first, second and third emitters to emit a nanosecond of infrared light.

16. The virtual electronic perimeter fence according to claim 12, wherein the control processor transmits a signal in a clockwise direction from the emitter disposed in the first fence post to the receiver disposed in the second fence post and then to the emitter disposed in the second fence post to the receiver disposed in the third fence post and then to the emitter disposed in the third fence post to the receiver disposed in the first fence post.

17. The virtual electronic perimeter fence according to claim 11, wherein the first, second and third fence posts include a first emitter and receiver that are positioned at a predetermined distance relative to a base of the first, second and third fence posts and a second emitter and receiver that are positioned at a predetermined distance displace downwardly relative to the first emitter and receiver for providing two beams of infrared light.

18. The virtual electronic perimeter fence according to claim 17, and further including a control processor for transmitting a signal in a clockwise direction from the first emitter disposed in the first fence post to the first receiver disposed in the second fence post and then to the first emitter disposed in the second fence post to the first receiver disposed in the third fence post and then to the first emitter disposed in the third fence post to the first receiver disposed in the first fence post and for transmitting a signal in a counter-clockwise direction from the second emitter disposed in the first fence post to the second receiver disposed in the third fence post and then to the second emitter disposed in the third fence post to the second receiver disposed in the second fence post and then to the second emitter disposed in the second fence post to the second receiver disposed in the first fence post.

19. The virtual electronic perimeter fence according to claim 11, and further including an alignment sight disposed on a top of the first, second and third fence posts for aligning adjacent fence post relative to each other.

20. The virtual electronic perimeter fence according to claim 11, and further including an alignment light emitting diode which is illuminated when the emitter and receiver of adjacent fence posts are properly aligned.

21. The virtual electronic perimeter fence according to claim 1, and further including a light mounted on at least one of the fence posts for providing illumination in an area adjacent to the fence post.

22. The virtual electronic perimeter fence according to claim 21, and further including a solar panel operatively connected to the light for providing power for illuminating said light.

23. The virtual electronic perimeter fence according to claim 21, wherein the light is hard wired into a supply of power for illuminating said light.

24. The virtual electronic perimeter fence according to claim 1, and further including a speaker mounted on at least one of the fence posts for providing sound to an area adjacent to the fence post.

25. The virtual electronic perimeter fence according to claim 24, wherein the speaker is hard wired to a sound system for providing sound to an area adjacent to the fence post.

26. The virtual electronic perimeter fence according to claim 24, wherein the speaker is wirelessly connected to a sound system for providing sound to an area adjacent to the fence post.

27. The virtual electronic perimeter fence according to claim 11, and further including a light mounted on at least one of the fence posts for providing illumination in an area adjacent to the fence post.

28. The virtual electronic perimeter fence according to claim 27, and further including a solar panel operatively connected to the light for providing power for illuminating said light.

29. The virtual electronic perimeter fence according to claim 27, wherein the light is hard wired into a low voltage supply of power for illuminating said light.

30. The virtual electronic perimeter fence according to claim 11, and further including a speaker mounted on at least one of the fence posts for providing sound to an area adjacent to the fence post.

31. The virtual electronic perimeter fence according to claim 30, wherein the speaker is hard wired to a sound system for providing sound to an area adjacent to the fence post.

32. The virtual electronic perimeter fence according to claim 30, wherein the speaker is wirelessly connected to a sound system for providing sound to an area adjacent to the fence post.

33. The virtual electronic perimeter fence according to claim 1, and further including a video camera mounted on at least one of the fence posts for viewing an area adjacent to the virtual electronic perimeter fence.

34. The virtual electronic perimeter fence according to claim 33, wherein the video camera is hard wired for providing a supply of power for the video camera.

35. The virtual electronic perimeter fence according to claim 33, wherein the video camera is supplied with power from a solar panel.

36. The virtual electronic perimeter fence according to claim 11, and further including a video camera mounted on at least one of the fence posts for viewing an area adjacent to the virtual electronic perimeter fence.

37. The virtual electronic perimeter fence according to claim 36, wherein the video camera is hard wired for providing a supply of power for the video camera.

38. The virtual electronic perimeter fence according to claim 37, wherein the video camera is supplied with power from a solar panel.
